(19) United States
(12) Patent Application Publication
(10) Pub. No.: US 2024/0295200 A1
(43) Pub. Date: Sep. 5, 2024

(54) EVAPORATED FUEL ADSORPTION DEVICE AND METHOD, EVAPORATIVE EMISSION CONTROL SYSTEM AND CORRESPONDING USE

(71) Applicant: SUMITOMO RIKO COMPANY LIMITED, Komaki-shi (JP)

(72) Inventors: Thiago Monteiro LIMA, Itaúna (BR); Rodolfo de Jesus NOGUEIRA, Betim (BR); Paulo Geovane SILVA, Juatuba (BR)

(73) Assignee: SUMITOMO RIKO COMPANY LIMITED, Komaki-shi (JP)

(21) Appl. No.: 18/664,406

(22) Filed: May 15, 2024

Related U.S. Application Data
(63) Continuation of application No. PCT/JP2022/044610, filed on Dec. 2, 2022.

(30) Foreign Application Priority Data
Dec. 23, 2021 (BR) 102021026387-3

(51) Int. Cl. F02M 25/08; B01D 53/04

(52) U.S. Cl. CPC F02M 25/0854; B01D 53/0407

(57) ABSTRACT

An evaporated fuel adsorption device or canister includes a first chamber and a second chamber fluidly interconnected through a communication region. The first chamber includes at least one first adsorbing sub-chamber and at least one first stabilizing sub-chamber. The second chamber includes at least one second adsorbing sub-chamber, at least one second stabilizing sub-chamber and at least one tapered adsorbing sub-chamber, all fluidly connected to one another, in series.

INCORPORATED BY REFERENCE

This application is a Continuation of International Application No. PCT/JP2022/044610 filed Dec. 2, 2022, which claims priority under 35 U.S.C. §§ 119(a) and 365 of Brazilian Patent Application No. 102021026387-3 filed on Dec. 23, 2021, the disclosures of which are expressly incorporated herein by reference in their entireties.

### BACKGROUND ART

### 1. Technical Field

The present invention relates to the field of systems, methods, devices and materials for reducing and controlling evaporative emissions in vehicle tanks with engines fed with hydrocarbons-derived fuels.

The present disclosure relates to a device and a method of evaporated fuel adsorption that alternately combines adsorption and stabilization steps, culminating in a final taper, ensuring the optimal use of the entire volume of adsorbing material in all adsorption steps, providing a drastic reduction in emissions while allowing the use of less adsorbing material, thus increasing efficiency and decreasing dimensions and, ultimately, costs. The disclosure also relates to an evaporative emission control system and the use of an evaporative emission control system comprising a fuel adsorption device.

### 2. Description of the Related Art

The volatility of hydrocarbons present in fuels used in automobiles is broadly acknowledged. From the point of view of the use of these fossil fuels to drive automobiles with combustion engines, it is known that, due to their volatility, they release vapors inside the fuel tank, promoting an increase in volume and therefore an increase in pressure inside the tank, which makes allowing the exit of these gases necessary to equalize the pressure and avoid fuel line malfunction and even mechanical deformations, both in the tank and in the pipes and accessories of the vehicle's supply system.

From an environmental point of view, releasing this kind of gases ultimately contributes to a greater concentration of pollutant gases in the atmosphere, in addition to fuel loss.

Several solutions in the present technical field seek ways to allow the release of vapors from inside of the fuel tanks, promoting the suppression of hydrocarbons in the path between the tank and the outlet or vent by means of carbon-based adsorbing materials, usually activated charcoal, releasing only the filtered vapors and returning the adsorbed portion to the vehicle's supply system. These solutions include devices called adsorption devices or canisters that are part of an evaporative emission control (EVAP) system.

Adsorption devices or canisters therefore need to reduce the emission of hydrocarbons from the vapors of the fuel tanks to the lowest possible value, preferably to zero, in addition to returning the adsorbed portion to the vehicle's fuel supply system, and all this without interfering with its operation.

Furthermore, as the canisters are part of the vehicle's fuel system, there are dimensional restrictions that limit the effectiveness of adsorption, in addition to weight and cost limitations and problems of adapting the shape of the canister to the available space.

Therefore, the challenge for specialized engineering around the world is to provide an efficient and effective, compact canister with low material, manufacturing, and assembly costs.

### PRIOR ART

Solutions known from the prior art to improve the fuel vapors adsorption can be verified in several documents from the prior art, such as the European patent document EP 1446569, entitled “Method, system and canister for reducing system emissions from evaporative emission control systems”, which describes a canister comprising various adsorbers to reduce daytime respiratory loss emissions from automotive evaporative emission control systems by providing various layers, or stages, of adsorbers. On the fuel-source side of an emission control system canister, high working capacity carbons are preferred in a first canister (adsorber) region. In the subsequent canister(s) region(s) on the ventilation side, the preferred adsorber should exhibit a flat or flattened adsorption isotherm on a volumetric basis and relatively lower capacity for high concentration vapors compared to the adsorber of the fuel-source side. Multiple approaches are described for attaining the preferred properties for the vent-side canister region. One approach is to use a filler and/or voids as a volumetric diluent to flatten the adsorption isotherm.

Note, however, that the teachings from EP 1446569 do not disclose or intend the uniformity of the distribution of moving vapor inside the chambers. Furthermore, EP 1446569 does not disclose the objective of using less material or reducing manufacturing costs, thus not providing an optimal configuration that seeks to optimize both adsorption and economy in the production of a canister.

Another patent document which solution can be mentioned is the US 2013/0186375 entitled “Trap canister capturing fuel vapor”, which describes a trap canister configured to trap fuel vapor contained in exhaust gas discharged from an adsorbing container. The trap canister has a housing defining an adsorption chamber therein, a breathable partition member disposed in the housing and dividing the adsorption chamber into a first chamber and a second chamber, an adsorber filled in the first chamber and the second chamber, and a latent recovery storage material filled in the first chamber in a mixed manner with the adsorbing. The first chamber is configured to receive exhaust gas, while the second chamber is configured to communicate with the atmosphere. The first chamber has a larger cross-sectional area than the second chamber.

However, US 2013/0186375 also does not accurately describe measures to reduce the cross-sectional area of the canister, mentioning only that one of the areas is larger than the other. Furthermore, US 2013/0186375 is also omissive on the air flow improvement from using the canister, mentioning only the reduction of vapor emission from fuels. Finally, said document also does not specifically address possible cost reductions for the production of a canister. Hence it is clear that the objects from US 2013/0186375 are of inferior performance, and do not have optimized constructive configurations that aim to reduce costs with regard to production.

Finally, it is worth mentioning that several prior art solutions can be verified in other patent documents such as U.S. Pat. No. 8,992,673, EP 3055546, and U.S. Pat. No. 8,015,965. In these documents, problems regarding the size of the canister are also identified, which also necessarily implies a high production cost. Additionally, the prior art canister has a constant vapor concentration of up to 75% of the total volume. Furthermore, attempts to optimize the canister are verified through the use of a stabilizing sub-chamber, as well as through the tapering of the atmospheric outlet chamber. However, it is not possible to obtain from these documents teachings that aim at a canister that uses a stabilizing sub-chamber, together with the tapering of the atmospheric outlet chamber, which can reduce costs and optimize the process of reuse of fuel evaporation gases.

Therefore, there is room for a canister capable of overcoming the problems of the prior art, which is both compact and low-cost and capable of optimizing fuel vapor flow, promoting its stabilization and standardizing its distribution inside the canister chambers and thus taking full advantage of the filtering material by practically eliminating “dead spaces” also near the outlet port of the atmospheric chamber.

### SUMMARY

One of the objects of this disclosure is providing an evaporated fuel adsorption device according to the characteristics of claim 1 of the appended set of claims.

Another object of the present disclosure is providing an evaporated fuel adsorption method according to the characteristics of claim 8 of the appended set of claims.

Another object of the present disclosure is providing an evaporative emission control system comprising an evaporated fuel adsorption device according to the characteristics of claim 9 of the appended set of claims.

Yet another object of this disclosure is the use of an evaporative emission control system comprising an evaporated fuel adsorption device, according to the characteristics of claim 10 of the appended claim set.

Additional characteristics and characteristics details are presented in the dependent claims.

### BRIEF DESCRIPTION OF THE DRAWINGS

To better understand and visualize the subject matter, the present disclosure will now be described with reference to the appended figure, representing the obtained technical effect by means of exemplary practical embodiments without limiting the scope of the present disclosure, in which:

FIG. 1: shows a schematic front view of an evaporated fuel adsorption device, according to the disclosure; and

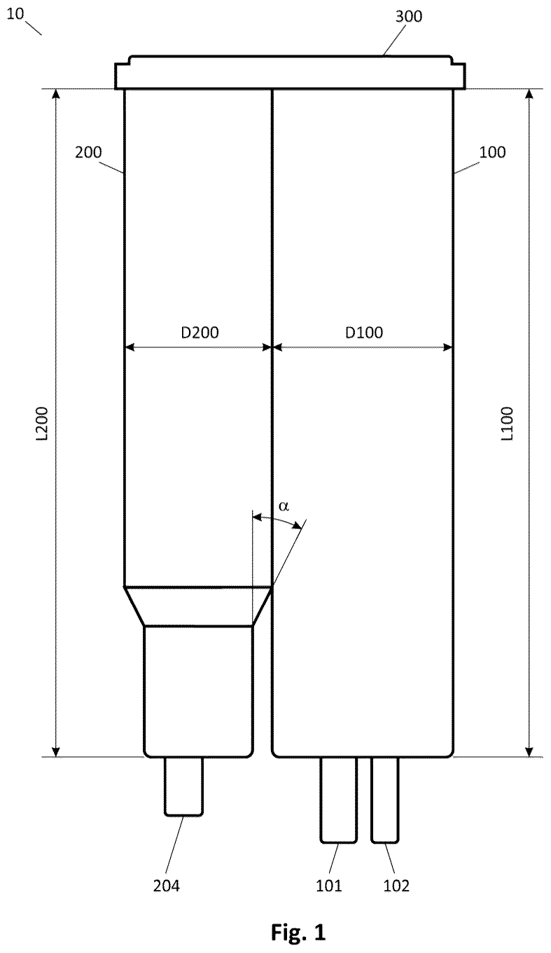

FIG. 2: shows a schematic front view partially in section of the FIG. 1.

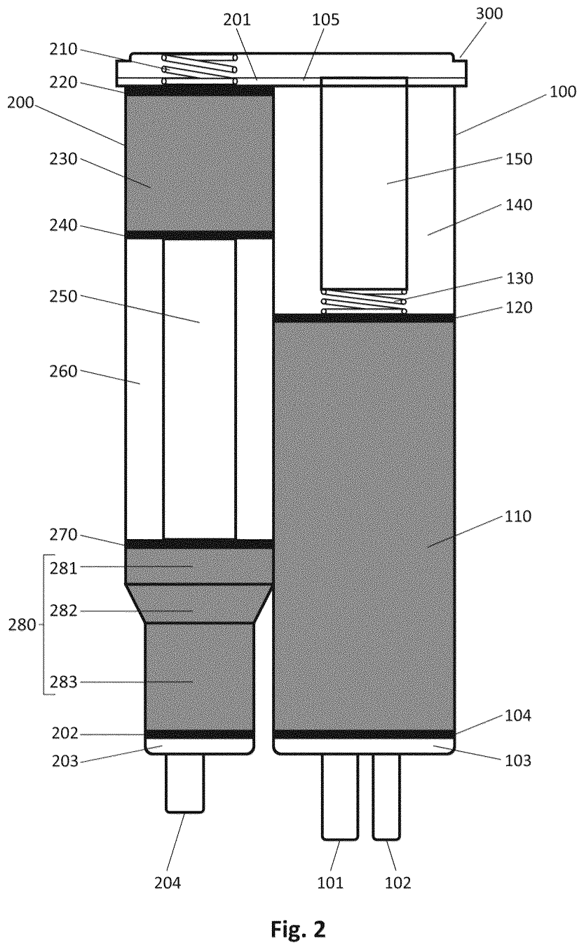

### DETAILED DESCRIPTION

The following detailed description refers to the appended drawings in which, by way of non-limiting illustration, practical embodiments of the present disclosure are shown. These practical embodiments are described so as to allow a person skilled in the art to reproduce their results. Other practical embodiments resulting from structural, mechanical, and logical changes are possible and can be carried out without departing from the spirit and scope of the present disclosure. The following detailed description should therefore not be understood in a restrictive or limiting manner.

### Device

An evaporated fuel adsorption device or simply canister (10), according to the disclosure, serves for the trap and adsorption of fuel vapors that operate through the trap, conduction and adsorption of fuel vapors from car tanks, where the filtered portion of the trapped vapor is released to the atmosphere and the adsorbed portion is returned to be reused in the combustion cycle of an internal combustion engine in an automobile.

The canister (10) comprises at least a first chamber (100) of length (L100) and diameter or width or maximum transverse dimension (D100) and at least a second chamber (200) of length (L200) and diameter or width or dimension maximum transversal (D200), fluidly interconnected by means of a communication region (300), in which the quotient (R) of the length and width (L/D) is such that the quotient of the first chamber (R100=L100/D100) corresponds to a value between 2 and 6, preferably between 3 and 5 and that the quotient of the second chamber (R200=L200/D200) corresponds to a value between 30% and 80%, preferably between 55% and 75% of the quotient of the first chamber (R100=L100/D100).

The first chamber (100) comprises at least one vapor trap opening (101), at least one purge opening (102), at least one inlet stabilization region (103) provided with an inlet restrictor (104), at least one first adsorbing sub-chamber (110), at least one first restrictor (120), at least one first spring (130), at least one first stabilizing sub-chamber (140), at least one first tubular spacer (150) and at least one first communication opening (105). The openings (101, 102, 105), the inlet stabilization region (103) and the sub-chambers (110, 140) are fluidly connected to one another in series.

The vapor trap opening (101) and the purge opening (102) are channels arranged at the lower end of the canister (10), preferably at the lower end of the first chamber (100), wherein the vapor trap opening (101) serves as a means of fluid communication between the canister (10) and the fuel tank, to receive fuel vapors, and the purge opening (102) serves as a means of fluid communication between the canister (10) and the supply system of the engine, to return the adsorbed fuel.

The inlet stabilization region (103) is a preferably empty region that allows the inlet vapors to be uniformly distributed before moving onwards to the first chamber (100), being separated from other components by an inlet restrictor (104), which it is an element provided with passing openings, so as to allow the free passage of fluids.

The first adsorbing sub-chamber (110) has a circular or polygonal cross-section, in which its internal volume is filled with adsorbing material, preferably carbon/activated charcoal that can be granulated and/or pelleted, used directly and/or in simple and/or complexes polygonal-type structured forms filled with granulated and/or pelleted material, which adsorbs and desorbs the portions of hydrocarbons from the vapors coming from the fuel tank in the path between the tank and the outlet to the atmosphere (vent).

The first restrictor (120) serves as a stop to keep the adsorbing material in position, being an element provided with passing openings, so as to allow the free passage of internal fluids between the first adsorbing sub-chamber (110) and the first stabilizing sub-chamber (140). The first tubular spacer (150) is sealed at its lower surface and exerts pressure therethrough on the first restrictor (120) by means of a first spring (130).

The first stabilizing sub-chamber (140) has a circular or polygonal cross-section and is an activated charcoal-free chamber, so as to allow the free passage of internal fluids in their path through the canister (10), promoting the stabilization of the vapor flow and standardizing the distribution of the fluid in the process, ensuring that the vapor passes to the next layer of adsorbing material with maximum volumetric grasping of activated charcoal, drastically reducing the “dead zones” so common among their peers of the same nature in the prior art.

It should be noted that the first chamber (100) may comprise more than one adsorbing sub-chamber (110), which may, for example, contain different adsorbing material or be arranged after the first stabilizing sub-chamber (140). Similarly, it is possible to have more than one stabilizing sub-chamber interleaved with adsorbing sub-chambers, which further improves the stabilization and standardization described above and thus additionally increases the volumetric use of activated charcoal.

The first communication opening (105) is in fluidic contact with the communication region (300) and is disposed at the end opposite to the vapor trap (101) and purge (102) openings, wherein the communication region (300) performs fluid communication between the first chamber (100) and the second chamber (200).

The second chamber (200) comprises at least one second communication opening (201), at least one second spring (210), at least one second restrictor (220), at least one second adsorbing sub-chamber (230), at least one third restrictor (240), at least one second tubular spacer (250), at least one second stabilizing sub-chamber (260), at least one fourth restrictor (270), at least one tapered adsorbing sub-chamber (280), at least one outlet restrictor (202), at least one outlet stabilization region (203) and at least one atmospheric opening (204). The openings (201, 204), the second adsorbing sub-chamber (230), the second stabilizing sub-chamber (260), the tapered adsorbing sub-chamber (280) and the outlet stabilization region (203) are fluidly connected to one another, in series.

The second communication opening (201) is in fluid contact with the communication region (300) and is located at one end of the second chamber (200) and is opposite to the atmospheric opening (202), in which the communication region (300) performs fluid communication between the second chamber (200) and the first chamber (100).

The second spring (210) is in direct contact with the second restrictor (220), the latter being a surface with pierced openings, so as to allow the free passage of internal fluids between the second communication opening (201) and the second adsorbing sub-chamber (230) and comprising a pocket corresponding to the second spring (210).

Springs (130, 210) are arranged to compact and stabilize the adsorbing material, performing a reactive load to the vehicle movement in their respective adsorbing sub-chambers (110, 230).

The second adsorbing sub-chamber (230) has a circular or polygonal cross-section, in which its internal volume is filled with adsorbing material, preferably activated charcoal that can be granulated and/or pelleted, used directly and/or in simple and/or complexes polygonal-type structured forms filled with granulated and/or pelleted material, which adsorbs and desorbs the portions of hydrocarbons from the vapors coming from the fuel tank, in which the second adsorbing sub-chamber (230) is found pressed between the restrictors (220, 240).

The second adsorbing sub-chamber (230) receives the stabilized flow with uniform distribution from the first stabilizing sub-chamber (140), which ensures that the vapor is equally distributed throughout the volume of adsorbing material, optimizing the volumetric grasping of activated charcoal, drastically reducing the “dead zones” so common among their peers of the same nature in the prior art.

The third restrictor (240) is a surface with pierced openings, so as to allow the free passage of internal fluids between the second adsorbing sub-chamber (230) and the second stabilizing sub-chamber (260), wherein said third restrictor (240) comprises a pocket corresponding to the second tubular spacer (250).

The second tubular spacer (250) is a hollow tube and has a cylindrical shape, being fitted and pressed between the third restrictor (240) and the fourth restrictor (270). The second tubular spacer (250) allows the passage of fluids.

The second stabilizing sub-chamber (260) has a circular or polygonal cross-section and is an activated charcoal-free chamber, so as to allow the free passage of the internal fluids of the canister (10) and is located between the second adsorbing sub-chamber (230) and the tapered adsorbing sub-chamber (280). The second stabilizing sub-chamber has a volume of from 10% to 60%, preferably from 20% to 50% and more preferably from 30% to 40% of the total volume of the second chamber (200).

The fourth restrictor (270) is a surface with pierced openings so as to allow the free passage of internal fluids between the second stabilizing sub-chamber (260) and the tapered adsorbing sub-chamber (280), in which said third restrictor (240) comprises a pocket corresponding with the second tubular spacer (250).

The tapered adsorbing sub-chamber (280) has a circular or polygonal cross-section and has its internal volume filled with adsorbing material, preferably activated charcoal that can be granulated and/or pelleted, used directly and/or in simple and/or complexes polygonal-type structured forms filled with granulated and/or pelleted material, which adsorbs and desorbs the portions of hydrocarbons from the vapors in process, comprising an inlet region (281), a tapered region (282) and an outlet region (283), wherein said tapered adsorbing sub-chamber (280) has a reduction in the cross-sectional area between the inlet region (281) and the outlet region (283), which varies between 20% and 80%, preferably between 30% and 70%, more preferably between 40% and 60%.

Additionally, the tapered adsorbing sub-chamber (280) has a volume representing up to 70%, preferably up to 60% and more preferably up to 50% of the total volume of the second adsorbing sub-chamber (230).

The inlet region (281) preferably has a cross-section and dimensions corresponding to those of the second stabilizing sub-chamber (260). The tapered region (282) has an internal angle (α) between 45° and 75°, preferably between 50° and 70°, more preferably between 55° and 65°. The outlet region (283) has a cylindrical shape and comprises the atmospheric opening (202).

The tapered adsorbing sub-chamber (280) receives the stabilized flow with uniform distribution from the second stabilizing sub-chamber (260), followed by a drastic reduction in cross-section, which together ensures that the vapor is equally distributed along the volume of adsorbing material, optimizing the volumetric grasping of activated charcoal, drastically reducing the “dead zones” so common among their peers of the same nature in the prior art.

This sequential combination of adsorption and stabilization, culminating in a final tapering of the disclosure, guarantees the optimized use of the entire volume of adsorbing material in the last adsorption step, since, in the prior art solutions to be overcome, the use of adsorbing material is usually limited, the vapor being adsorbed by only a restricted portion of the charcoal/carbon volume on its way to the atmospheric opening (204). Thus, the canister (10) of the disclosure, in addition to providing a drastic reduction in hydrocarbon emissions, also allows the use of less adsorbing material, thereby increasing efficiency and reducing dimensions and, finally, costs. The cost reduction provided by the canister (10) according to the disclosure reaches 30%.

The outlet stabilization region (203), on the other hand, is a preferably empty region that allows the outlet vapors to be uniformly distributed before leaving the second chamber (200) onwards to the atmosphere, being separated from the other components by an outlet restrictor (202), which it is an element provided with passing openings, so as to allow the free passage of fluids.

Finally, the atmospheric opening (204) is an opening that is in fluid contact with the external environment/atmosphere, allowing the filtered vapor to escape.

In a non-limiting practical embodiment of the disclosure, the canister (10) can be produced as a single piece provided with a cap-shaped communication region (300).

In a non-limiting practical embodiment of the disclosure, a plurality of additional stabilizing sub-chambers may be employed within the canister (10), preferably 1 to 4 additional stabilizing sub-chambers may be employed, more preferably 1 to 2 additional stabilizing sub-chambers may be employed.

In a further non-limiting practical embodiment of the disclosure that contains more than one stabilizing sub-chamber per chamber (100, 200) inside the canister (10), preferably, the stabilizing sub-chambers are positioned so as to be interleaved with the adsorbing sub-chambers. Furthermore, the amount of stabilizing sub-chambers and adsorbing sub-chambers can be increased, so as to keep the stabilizing sub-chambers and the adsorbing sub-chambers interleaved to one another.

### Method

An evaporated fuel adsorption method according to the disclosure is a method performed by an evaporated fuel adsorption device of the disclosure, comprising:
i. receiving fuel vapors in a first adsorbing sub-chamber (110);
ii. conveying the vapors from the first adsorbing sub-chamber (110) to a first stabilizing sub-chamber (140);
iii. conveying the vapors from the first stabilizing sub-chamber (140) to a second adsorbing sub-chamber (230) through a first communication opening (105) and a second communication opening (201);
iv. conveying the vapors from the second adsorbing sub-chamber (230) to a second stabilizing sub-chamber (260);
v. conveying the vapors from the second stabilizing sub-chamber (260) to a tapered adsorbing sub-chamber (280); and
vi. conveying the vapors from the tapered adsorbing sub-chamber (280) to the atmosphere.

### Evaporative Emission Control System

An evaporative emission control system according to the disclosure is a system comprising at least one evaporative fuel adsorption device of the disclosure that performs an evaporative fuel adsorption method of the disclosure.

### Use

The use according to the disclosure is the use of an evaporative emission control system of the disclosure in a vehicle fuel supply system.

### Final Remarks

Note that the prior art does not provide versatile and economical solutions that take better advantage of the properties and advantages provided by the use of canisters, with an improved configuration.

A canister according to the present disclosure promotes an optimized configuration, which contains a plurality of stabilizing sub-chamber and a tapering in the air outlet chamber, which results not only in an economy of resources used for the production of said canister but also in a stable and optimized airflow in and out of the canister, optimizing the number of adsorbed materials and reducing fuel costs.

By employing, for example, a plurality of stabilizing sub-chambers interleaved with adsorbing sub-chambers inside the canister, the performance of a canister is improved, since, in addition to the adsorption provided by the canister being improved, there is also an economy in the production of the canister, resulting from reduced use of carbon/charcoal.

Another possible example of improving the performance of a canister is the structural modification of the atmospheric outlet of said canister. By inserting a tapering in place of the old square shape, it is possible not only to generate economy in the production of the canister but also improve the control and stabilization of the airflow release to the atmosphere.

Therefore, there are many advantages of using a canister that uses a stabilizing sub-chamber, together with the tapering of the atmospheric outlet chamber (compared to using only one of the two configurations), among which the greater economy and ease in the production process, greater trap of vapors from fuels, an optimization of the flow of vapor fluids, greater fuel savings, in addition to contributing to a cleaner and more sustainable process.

Furthermore, an additional advantage provided by the present disclosure is the reduction of hydrocarbon emission from everyday fuel vapors (DBL emission) from 91 mg to just 15 mg per day.

Yet another additional advantage provided by a canister (10) that makes use of both a stabilizing sub-chamber and a tapering of the atmospheric outlet chamber, is that said canister (10) also guarantees a better distribution of fuel vapors within the canister (10), allowing a better use of both the internal volume and the carbon/activated carbon thereof.

Another additional advantage provided by a canister (10) that makes use of both a stabilizing sub-chamber and a tapering of the atmospheric outlet chamber is the reduction of up to 30% in the production cost of said canister (10).

### CONCLUSION

It will be easily understood by a person skilled in the art that modifications can be made to the present disclosure without departing from the 5 concepts set out in the description above. Such modifications should be considered as included within the scope of the present disclosure. Consequently, the particular practical embodiments previously described in detail are merely illustrative and exemplary, and not limitative in terms of the scope of the present disclosure, to which the full extent of the accompanying claims should be given, in addition to all and any equivalents thereof.

1.-10. (canceled)

11. An evaporated fuel adsorption device or canister comprising:
a first chamber and a second chamber fluidly interconnected through a communication region, wherein
the first chamber comprises at least one first adsorbing sub-chamber and at least one first stabilizing sub-chamber, and
the second chamber comprises at least one second adsorbing sub-chamber, at least one second stabilizing sub-chamber and at least one tapered adsorbing sub-chamber, all fluidly connected to one another, in series.

12. The device according to claim 11, wherein the second stabilizing sub-chamber is located between the second adsorbing sub-chamber and the tapered adsorbing sub-chamber and has a volume that is from 10% to 60% of a total volume of the second chamber.

13. The device according to claim 11, wherein
the tapered adsorbing sub-chamber comprises an inlet region, a tapered region and an outlet region, and
a reduction of a cross-sectional area, between the inlet region and the outlet region, varies between 20% and 80%.

14. The device according to claim 11, wherein the tapered adsorbing sub-chamber has a volume that corresponds to up to 70% of a total volume of the second adsorbing sub-chamber.

15. The device according to claim 11, wherein the tapered region has an internal angle between 45° and 75°.

16. The device according to claim 11, wherein
the first chamber further comprises at least one inlet stabilization region, and
the second chamber comprises at least one outlet stabilization region.

17. The device according to claim 11, wherein
the first chamber has length (L100) and diameter or width or maximum transverse dimension (D100),
the second chamber has length (L200) and diameter or width or maximum transverse dimension (D200),
a quotient of the first chamber (R100=L100/D100) corresponds to a value between 2 and 6, and
a quotient of the second chamber (R200=L200/D200) corresponds to a value between 30% and 80% of the quotient of the first chamber (R100=L100/D100).

18. An evaporated fuel adsorption method carried out by the evaporated fuel adsorption device defined in claim 11, the method comprising:
i. receiving fuel vapors in the first adsorbing sub-chamber;
ii. conveying the vapors from the first adsorbing sub-chamber to the first stabilizing sub-chamber;
iii. conveying the vapors from the first stabilizing sub-chamber to the second adsorbing sub-chamber through a first communication opening and a second communication opening;
iv. conveying the vapors from the second adsorbing sub-chamber to the second stabilizing sub-chamber;
v. conveying the vapors from the second stabilizing sub-chamber to the tapered adsorbing sub-chamber; and
vi. conveying the vapors from the tapered adsorbing sub-chamber to the atmosphere.
